(19) United States
(12) Patent Application Publication
(10) Pub. No.: US 2023/0180711 A1
(43) Pub. Date: Jun. 15, 2023

(54) Slow Feed Pet Bowl With Insert

(71) Applicant: John J. Stone, Golden, CO (US)

(72) Inventor: John J. Stone, Golden, CO (US)

(21) Appl. No.: 17/552,155

(22) Filed: Dec. 15, 2021

(51) Int. Cl. A01K 5/01

(52) U.S. Cl. CPC A01K 5/0128

(57) ABSTRACT

A novel pet slow feed stainless steel bowl with a removable rubber insert. The insert has channels molded into it so that kibble placed in the bowl settles into the channels and causes the pet to eat slowly and deliberately. The rubber insert is easily removed for cleaning. The bowl and mat can also be used when traveling and can hold kibble on the mat set on a surface outside the bowl, and then water can be placed in the bowl. The bowl holds two cups of kibble or water.

### FIELD

The invention relates to a novel pet bowl which has a removable insert with patterns to slow consumption by a pet and has a stainless-steel bowl portion with molded notches to hold the removable rubber insert.

### BACKGROUND OF THE INVENTION

The invention most closely corresponds with USPTO Class 119/51.01 wherein Class 119 relates to animal husbandry and sub-class 51.01 includes feeding devices.

In its simplest form, the invention relates to a novel pet feeder wherein a stainless-steel bowl has a patterned removable insert designed to slow the consumption of a pet, and to be easily cleanable by the pet owner.

The stainless bowl has 4 tabs that extend from the bottom of the inside of the bowl to hold the rubber feeder mat in place. The mat has 4 square indentations for aligning with the bowl tabs and then turning the mat to lock in place. When the pet owner wants to clean the bowl, they can simply remove the insert for hand washing and put the bowl in the dishwasher.

A unique feature of the feeder is the removable insert that has a maze pattern molded into it so as to slow the pet's consumption rate. Kibble is poured into the bowl portion and will then randomly rest in the grooves or nooks molded into the bowl. A pet cannot then simply gobble down a bowl of food, but rather must pick its way through the maze of grooves to more carefully select kibble.

### THE INVENTION

### SUMMARY, OBJECTS AND ADVANTAGES

It is fairly well known that overweight dogs can experience a myriad of medical problems, which could be avoided by maintaining a healthy weight. These health problems can drastically shorten a dog's life. Weight related illnesses include diabetes, heart disease, arthritis and the list goes on.

It is also known that most dogs do not observe a limit at mealtimes and especially puppies will eat far past the full stage. Thus, pet owners must monitor or measure food, or purchase some feeding device that hopefully controls portions. Not all such feeding devices work well or are practical in all situations.

Applicant has several slow feed bowl designs on the market wherein the bowls are a single piece. Consumers desire something that is easy to clean, and is also dishwasher safe. Most plastic or rubber pet food bowls cannot be placed in dishwashers and tend to crack with age. Having a stainless-steel bowl is advantageous in that it is more durable than other materials and can be washed with very hot water.

With the rubber insert a pet owner can control the amount and rate of food consumption as well as “tricking” the pet into thinking they have eaten a large meal only because they have had to work hard for it.

The rubber insert is easily lifted out of the bowl by the pet owner and rinsed in warm water to clean. The bowl can also be used without the insert, which is another advantage over the one-piece slow feed bowls on the market. The bowl holds 2 cups of wet or dry food/water, and the removeable rubber insert is BPA, PVC, and lead-free. This bowl is novel in the market.

### BRIEF DESCRIPTION OF THE DRAWINGS

The invention is described in further detail by reference six (6) drawings sufficient in detail to describe the invention in which:

FIG. 1 is a perspective view of the stainless bowl with rubber insert;

FIG. 2 is a top-down view of the bowl and insert;

FIG. 3 is the bottom of the bowl with non-slip features;

FIG. 4 is a right side perspective with the molded tabs in phantom;

FIG. 5 is a left side perspective with the molded tabs in phantom; and

FIG. 6 is an exploded view of the bowl and mat.

### DETAILED DESCRIPTION, INCLUDING BEST MODES OF CARRYING OUT THE INVENTION

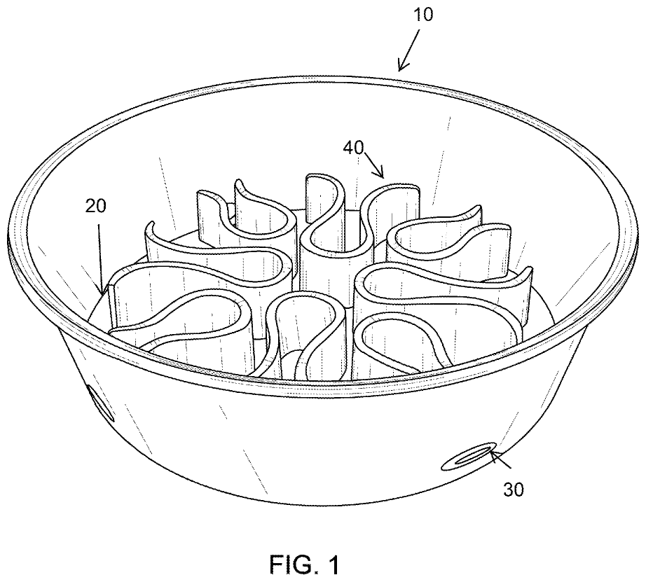

FIG. 1 shows the stainless-steel bowl 10 with the rubber slow feed mat 20 as inserted under the molded tabs in the bowl 30 so that it is firmly seated. The patterns 40 are molded in the mat to create channels for kibble to be inserted. These patterns cause the pet to pick and choose kibble versus having a large pile of it to gobble down quickly. This Figure also shows where the bowl's molded tabs 50 are located and which extrude into the interior of the bowl to hold the feeder mat in place.

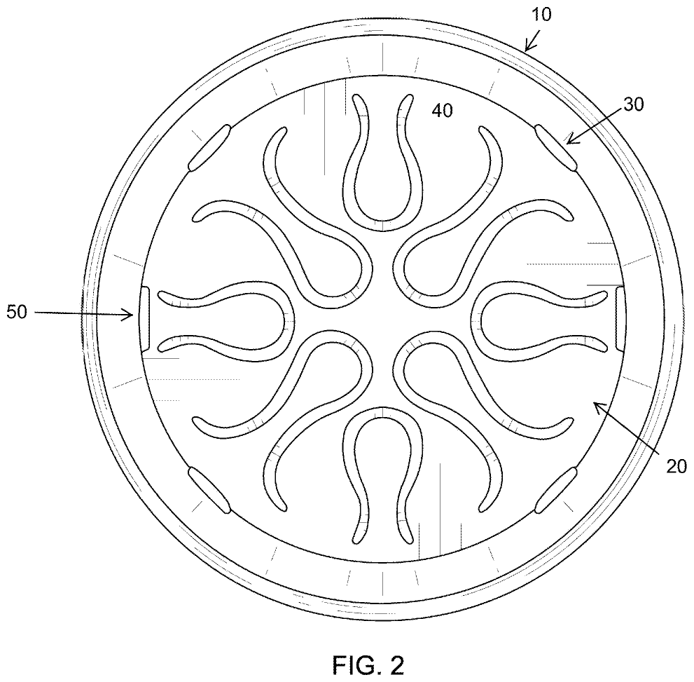

FIG. 2 is a top-down view of the bowl 10 and mat 20. Again, the channels of the mat 40 are shown, and the 4 molded tabs 30 extruding into the interior of the bowl. Squared indentations in the mat 50 are for aligning with the tabs on the bowl and turning the mat away from the tabs to lock in place. The pet owner can place the amount of kibble they want the pet to have at any particular time. The pet then has to get the kibble from the channels which takes more time than if it were able to eat from a pile of kibbles.

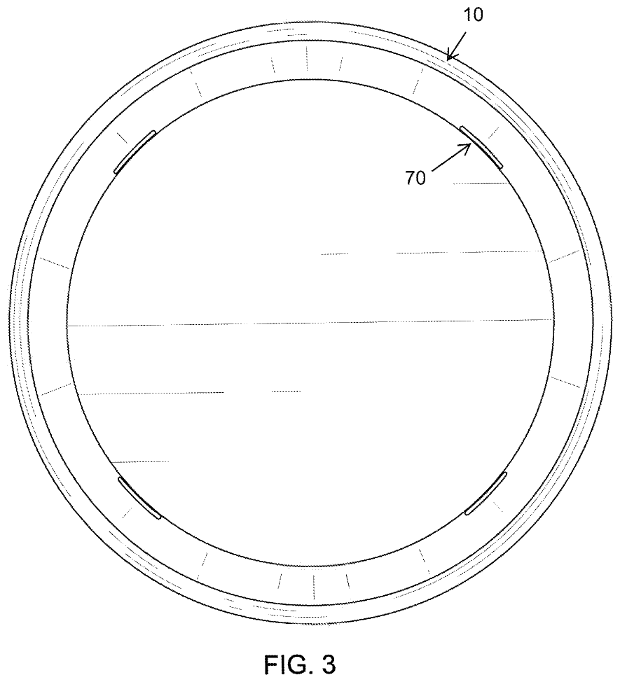

FIG. 3 shows the bottom of the bowl 10 and non-slip features 70 so the bowl does not slide when the pet is eating.

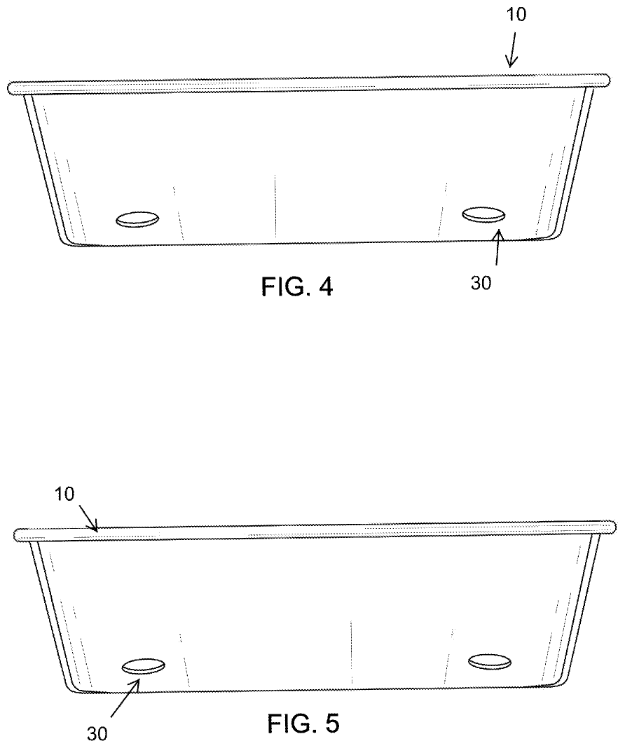

FIG. 4 is a simple right perspective of the bowl 10 with basic tab 30 position in phantom. It is clear that the stainless-steel bowl is a single piece.

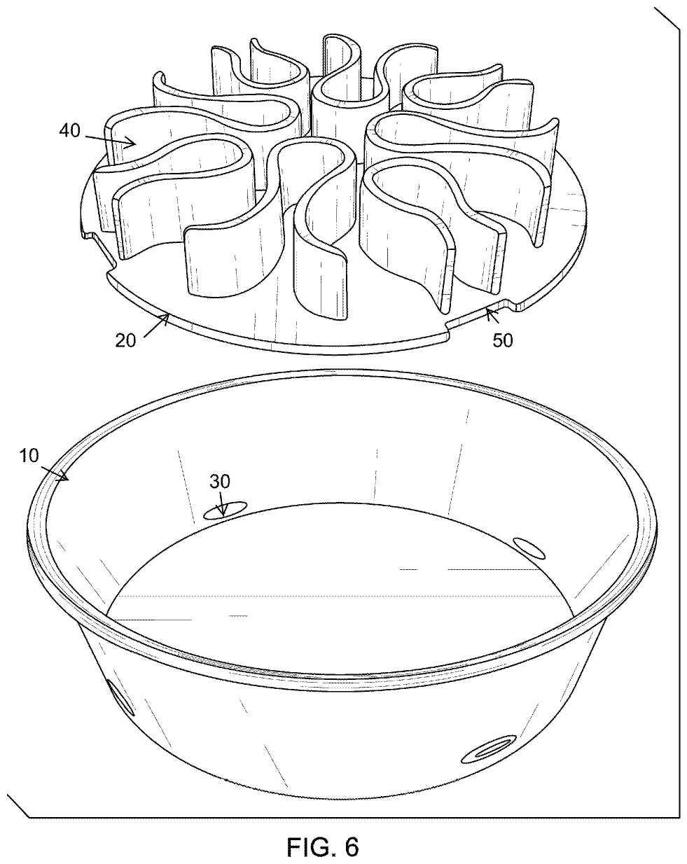

FIG. 5 is a simple left perspective of the bowl 10 with basic tab 30 position in phantom.

FIG. 6 is an exploded view of the bowl 10 and slow feed mat 20 removed. In this view square notches in the mat 50 aid in slipping the mat under the molded tabs 30 in the bowl and then turning to lock in place.

1. A stainless-steel feeding bowl with a removeable rubber insert comprising:
a) a stainless-steel bowl for receiving a removable rubber insert
b) extruding tabs molded into the bowl portion
c) square cutouts in the removeable rubber insert
d) grooved patterns on the removable insert
e) non-slip tabs on bottom of the bowl

2. The stainless-steel feeding bowl of claim 1 wherein the bowl can hold two cups of dry food or water, and wherein only 4 tabs molded into the bowl extrude into the interior of the bowl.

3. The stainless-steel feeding bowl of claim 1 wherein a removeable rubber insert is BPA, PVC, and lead-free.

4. The stainless-steel feeding bowl of claim 1 wherein the removable rubber insert contains only 4 square cutouts for placing under the extruding tabs in the bowl whereby the insert is tuned to clear the tabs and lock the insert in place.

5. The stainless-steel feeding bowl of claim 1 wherein the removeable rubber insert has channels molded within so that food kibble rests within the channels to force a pet to access kibble from within the individual channels slowing food consumption.

6. The stainless-steel feeding bowl of claim 1 wherein non-slip features are located on the bottom of the bowl so it will not slide on smooth surfaces.
